(19) United States
(12) Patent Application Publication
(10) Pub. No.: US 2024/0163228 A1
(43) Pub. Date: May 16, 2024

(54) RESOURCE ALLOCATION UPDATE DEVICE, RESOURCE ALLOCATION UPDATE METHOD, PROGRAM, AND VIRTUAL MACHINE/CONTAINER CONTROL SYSTEM

(71) Applicant: Nippon Telegraph and Telephone Corporation, Tokyo (JP)

(72) Inventors: Katsumi FUJITA, Musashino-shi, Tokyo (JP); Eriko IWASA, Musashino-shi, Tokyo (JP); Masashi KANEKO, Musashino-shi, Tokyo (JP)

(21) Appl. No.: 18/275,355

(22) PCT Filed: Feb. 12, 2021
(86) PCT No.: PCT/JP2021/005148

§ 371 Date: Aug. 1, 2023

(51) Int. Cl. H04L 47/70; H04L 47/80

(52) U.S. Cl. CPC H04L 47/82; H04L 47/805

(57) ABSTRACT

A controller includes a monitor function unit that collects data indicating a state of a compute group having servers as computes, a storage that stores resource information indicating resources, a scheduler that acquires the data collected by the monitor function unit and select an optimization algorithm corresponding to each application to be execute in the virtual machine/container on the basis of the data, and a resource management unit theta acquires resource information and selects a server corresponding to an optimization purpose of the optimization algorithm from server information related to the server described in the resource information on the basis of a predetermined server priority.

### CROSS-REFERENCE TO RELATED APPLICATIONS

This application is a National Stage application under 35 U.S.C. § 371 of International Application No. PCT/JP2021/005148, having an International Filing Date of Feb. 12, 2021. The disclosure of the prior application is considered part of the disclosure of this application, and is incorporated by reference in its entirety into this application.

### TECHNICAL FIELD

The present invention relates to a resource allocation update device, a resource allocation update method, a program, and a virtual machine/container control system.

### BACKGROUND ART

In recent years, with the spread of cloud services and IoT (Internet of Things), an increase in server power consumption in a data center associated with an increase in data processing and accumulation has become a problem.

Here, for example, a technique for optimizing the amount of use and power consumption of physical resources by scaling (scale-in, scale-out or the like) and migration by using a virtual machine or a container, and a technique with respect to mechanism (DVFS: Dynamic Voltage and Frequency Scaling) for changing the clock frequency and voltage of a CPU (central processing unit) are disclosed (see, for example, NPLs 1 to 5).

### CITATION LIST

### Non Patent Literature

[NPL 1] Beloglazov, Anton, Jemal Abawajy, and Rajkumar Buyya. “Energy-aware resource allocation heuristics for efficient management of data centers for cloud computing.” Future generation computer system 28.5 (2012): 755-768.
[NPL 2] Than, Moh Moh, and Thandar Thein. “Energy-Saving Resource Allocation in Cloud Data Centers.” 2020 IEEE Conference on Computer Applications (ICCA). IEEE, 2020.
[NPL 3] “A good question related to enhanced Intel SpeedStep technology of the Intel processor”, [online], Intel, [retrieval on Jan. 29, 2021], <URL: https://www.intel.co.jp/content/www/jp/ja/support/articles/000007073/p rocessors.html>
[NPL 4] “AMD PowerNow! Technology,”, [online], @ IT, [retrieval on Jan. 29, 2021], <URL: https://www.atmarkit.co.jp/fpc/keyword/powernow/powernow.html>
[NPL 5] “CPU frequency scaling,”, [online], ArchLinux, [retrieval on Jan. 29, 2021], <URL: https://wiki.archlinux.jp/index.php/CPU_%E5%91%A8%E6%B3%A2%E6%95%B0%E3%82%B9%E3%82%B1%E3%83%BC %E3%83%AA %E3%83%B3%E3%82%B0>

### SUMMARY OF INVENTION

### Technical Problem

By the way, conventionally, performance degradation may occur due to mismatch between requirements of applications implemented on virtual machines and containers and setting of the clock frequency control function by the DVFS of the server. Specifically, power consumption reduction by a clock frequency control function and performance are in a trade-off relationship, and in an application (application requiring high performance) requiring severe performance requirements, suppression of a clock frequency by the DVFS of the server may cause performance degradation.

In this case, it is necessary to properly use and manage the server group (compute group) having different settings.

In view of such a problem, the present invention has been made, and it is an object of the present invention to reduce the power consumption of the server while satisfying the requirements of the application to be implemented.

### Solution to Problem

A resource allocation update device according to the present invention includes
a monitor function unit that collects data indicating a state of a compute group having a plurality of servers for realizing a plurality of types of virtual machines/containers as compute,
a storage unit that stores resource information indicating resources of the plurality of types of virtual machines/containers in a database,
a scheduler that acquires the data collected by the monitor function unit and selects an optimization algorithm corresponding to each application to be executed in the virtual machine/container on the basis of the data, and
a resource management unit that acquires the resource information from the database and selects a server corresponding to the optimization purpose of the optimization algorithm from server information related to the server described in the resource information on the basis of a predetermined server priority, wherein
the scheduler is characterized in that
the scheduler executes the optimization algorithm for the server selected by the resource management unit based on the predetermined server priority and executes an optimal arrangement estimation of the virtual machine/container.

### Advantageous Effects of Invention

According to the present invention, power consumption of a server can be reduced while satisfying a request of an application to be implemented.

### BRIEF DESCRIPTION OF DRAWINGS

FIG. 1 is an explanatory diagram showing a configuration of a virtual machine/container control system according to an embodiment.

FIG. 2 is an explanatory diagram showing resource information stored in a storage.

FIG. 3 is a diagram for explaining an authority of the frequency control unit, a power mode, and a power mode flag.

FIG. 4 is a flowchart showing a flow of processing executed by a scheduler and a resource management unit in a controller (part 1).

FIG. 5 is a flowchart showing the flow of processing executed by the scheduler and the resource management unit in the controller (part 2).

FIG. 6 is a flowchart showing the flow of processing executed by the scheduler and the resource management unit in the controller (part 3).

FIG. 7 is a flowchart showing the flow of processing executed by the scheduler and the resource management unit in the controller (part 4).

FIG. 8 is a flowchart showing the flow of processing executed by the scheduler and the resource management unit in the controller (part 5).

FIG. 9 is an explanatory diagram showing resource information acquired from a resource database of the storage.

FIG. 10 is a diagram showing resource information (selection information) in which a server is selected as a candidate of an arrangement destination server from the resource information of FIG. 9.

FIG. 11 is a diagram of resource information indicating a result of execution of optimal arrangement estimation on the server of the resource information of FIG. 10.

FIG. 12 is an explanatory diagram in which the resource management unit updates the resource information of FIG. 9 on the basis of the resource information of FIG. 11.

FIG. 13 is a hardware configuration diagram showing an example of a computer that realizes functions of the controller according to a first embodiment.

FIG. 14 is a diagram of resource information showing a server that becomes an arrangement destination candidate at the time of optimal arrangement estimation.

FIG. 15 is an explanatory diagram in which the resource management unit selects a server in which the power mode is Performance mode as a candidate for an arrangement destination server from resource information.

FIG. 16 is an explanatory diagram in which a resource management unit selects a server in which the power mode is Energy saving mode as a candidate for an arrangement destination server from resource information.

FIG. 17 is an explanatory diagram showing resource information in which the resource management unit selects a server in which the power mode is Energy saving mode as a candidate for an arrangement destination server from the resource information, and adds a server in which the power supply is OFF the selection of the candidate.

### DESCRIPTION OF EMBODIMENTS

Hereinafter, embodiments of the invention will be described in conjunction with the accompanying drawings.

### Present Embodiment

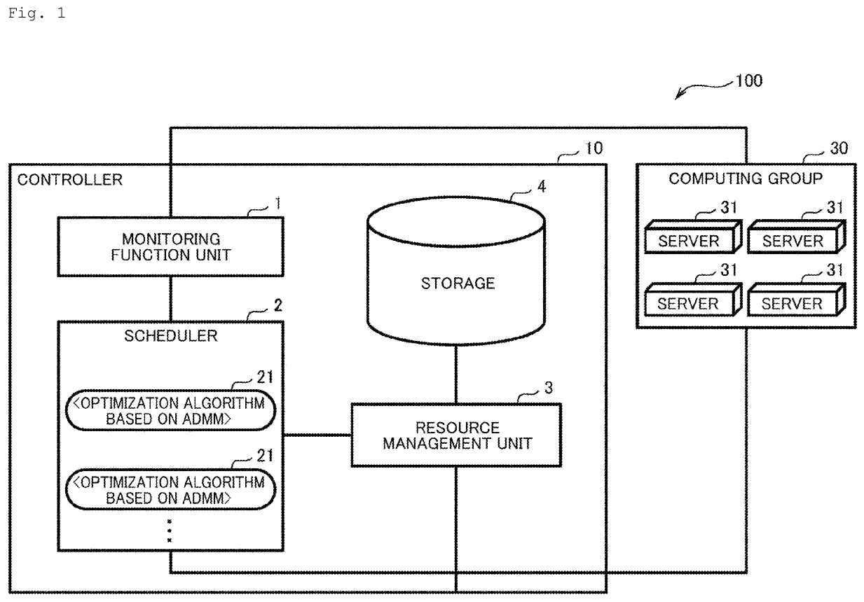

FIG. 1 is an explanatory diagram showing a configuration of a virtual machine/container control system 100 according to a present embodiment.

As shown in FIG. 1, the virtual machine/container control system 100 is configured to includes a controller 10 (a resource allocation update device) and a compute group 30.

In the virtual machine/container control system 100, the controller 10 is connected to the compute group 30 connected by a network via a network.

The compute group 30 has a plurality of servers 31 for realizing a plurality of types of virtual machines/containers. Each server 31 constitutes a compute and implements a plurality of types of virtual machines/containers. Note that each server 31 is constituted by a physical server.

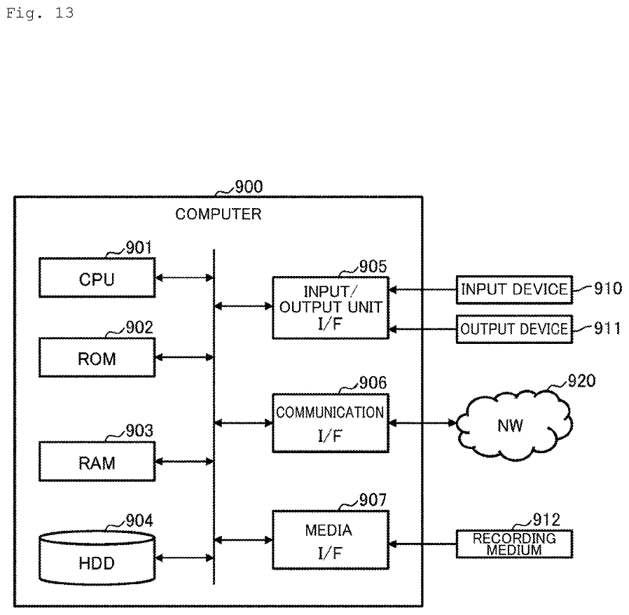

The controller 10 is configured to includes a monitor function unit 1, a scheduler 2, a resource management unit 3, and a storage 4 (a storage unit). The controller 10 is constituted by a physical server. A hardware configuration of the controller 10 is described later by using FIG. 13.

The monitor function unit 1 collects data indicating a state of a compute group 30. The monitor function unit 1 transmits the collected data to the scheduler 2. The data collected by the monitor function unit 1 corresponds to resource use information (free information) of a plurality of types of virtual machines/containers, a value indicating performance of each server 31, or power consumption.

The scheduler 2 acquires the data collected by the monitor function unit 1, and selects an optimization algorithm 21 corresponding to each application to be executed in the virtual machine/container on the basis of the data.

In the present embodiment, the scheduler 2 includes a plurality of optimization algorithms 21, and executes scaling and migration for a deployment at a start of a new service or a service under operation. The scheduler 2 selects an optimal arrangement estimation algorithm suitable for each requirement of each application from the plurality of optimization algorithms 21, and then executes optimal arrangement estimation and control of the plurality of types of virtual machines/containers.

Further, the scheduler 2 can execute a plurality of optimal arrangement estimation algorithms defining different objective functions, and can selectively use the optimal arrangement estimation algorithms according to the requirements of the application. The scheduler 2 may also add a desired optimization algorithm 21.

For example, the power consumption and a service level agreement (SLA) requirement of the server 31, the cost required for the rearrangement of the virtual machine, the cost required for the change by a BIOS (Basic Input/Output System) or an OS (operating system), and the like can be set as the objective function and a constraint condition of the optimization.

Specifically, an algorithm for estimating a necessary virtual machine/container to be scaled and an arrangement destination can be added to guarantee QoS (Quality of Service) by using SLA requirement violation of a service in a certain application as a trigger. Also, an algorithm for estimating an arrangement for reducing power consumed by components constituting the application and suppressing power cost during migration as much as possible by using fluctuation of power consumption of the server 31 as a trigger can be added.

In addition, the scheduler 2 executes the optimization algorithm 21 to the server 31 selected by the resource management unit 3 on the basis of the predetermined server priority, and executes the optimal arrangement estimation of the virtual machine/container.

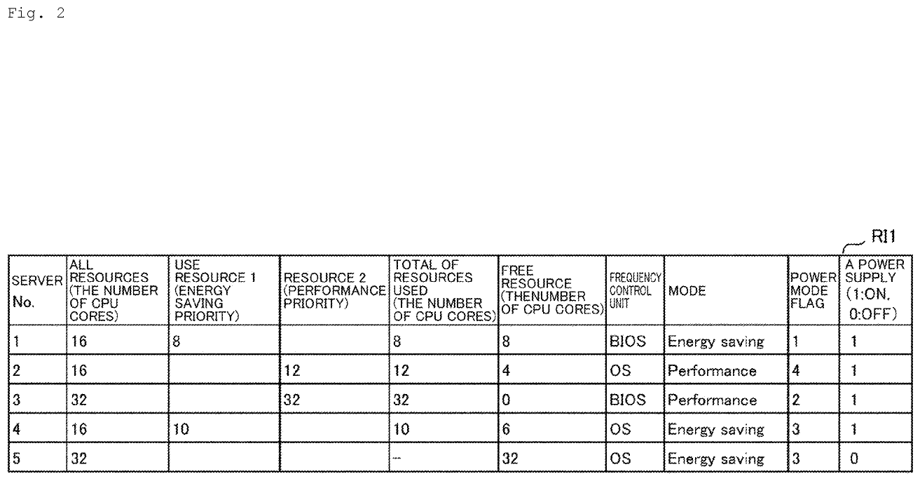

The storage 4 stores resource information indicating resources of a plurality of types of virtual machines/containers in a resource database. Details of the resource information will be described later with reference to FIG. 2 and the like.

The resource management unit 3 acquires resource information from the resource database of the storage 4, and selects the server 31 corresponding to an optimization purpose of the optimization algorithm 21 from server information related to the server 31 described in the resource information on the basis of the predetermined server priority.

In the present embodiment, the resource management unit 3 manages and controls the amount of use of the physical resource and the virtual resource, ON/OFF of the power supply of the server 31, the setting information of the DVFS, and the like. That is, the resource management unit 3 executes management and control of resources for realizing efficiency of use of the server 31 for the purpose of application requirements and power saving in addition to optimal arrangement estimation by the scheduler 2.

For example, when executing optimal arrangement estimation by the scheduler 2, the resource management unit 3 selects the server 31 group of appropriate setting from all servers 31 as an arrangement destination candidate so as not to cause mismatch between the optimization purpose of the application and the setting of the server 31, and transmits resource information such as idle resources to the scheduler 2. In this case, the resource management unit 3 sets the priority of the server 31 to the resource information(that is, predetermined server priority), and can set a restriction to idle resource information to be transmitted to the scheduler 2 stepwise.

Therefore, the scheduler 2 can execute the optimal arrangement estimation within the server 31 groups of the number smaller than that of the actually available servers 31, and can control the servers 31.

Specifically, the scheduler 2 selects a candidate group of the placement destination server on the basis of priority set for each purpose (optimization purpose) of the optimization algorithm 21. Examples of optimization purposes include “performance guarantee priority”, “power consumption reduction priority” and the like. As an index of the priority of the server, there are power saving mode setting (ON/OFF of a clock frequency control function) of the server 31, ON/OFF of a power supply, and the like.

The clock frequency control function is an example of power saving mode setting, and power saving modes other than the clock frequency control function can be set.

After the server 31 to be used by the scheduler 2 is determined, the resource management unit 3 executes start-up of the server 31, setting change of a power saving mode (energy saving function) of the server 31, and the like, as necessary. In this case, for example, the resource management unit 3 can change energy saving setting from the OS or the BIOS, and energy saving setting can be applied to both the OS and the BIOS.

The resource management unit 3 can turn off the power supply to a server 31 not used as a resource among the servers 31 indicated by the resource information.

### <Resource Information of Storage>

FIG. 2 is an explanatory diagram showing resource information RI1 stored in the storage 4. As one example, in the resource information RI1, information on physical resources and virtual resources is managed in a database (this is referred to as a resource database).

In FIG. 2, as an example, resource information is expressed by the number of CPU cores. Note that the resource is not limited to the number of CPU cores, and, for example, a memory capacity, a capacity of a hard disk may be used.

The resource information RI1 shown in FIG. 2 includes items (columns) of a server No., all resources (the number of CPU cores), a use resource 1 (energy saving priority), a use resource 2 (performance priority), a total of use resources (the number of CPU cores), an idle resource (the number of CPU cores), an authority of frequency control unit, a power mode, a power mode flag, and power supply(1: ON, 0: OFF).

For example, a server No. 1 is configured so that all resources (the number of CPU cores) are 16, the use resource 1 (energy saving priority) is 8, the total of use resources (the number of CPU cores) is 8, the idle resource (the number of CPU cores) is 8, the authority of the frequency control unit is the BIOS, the power mode is Energy saving mode, the power mode flag is 1, and the power supply (1: ON, 0: OFF) is 1.

In addition, a server No. 2 is configured so that all resources (the number of CPU cores) are 16, the use resource 2 (performance priority) is 12, the total of use resources (the number of CPU cores) is 12, the idle resource (the number of CPU cores) is 4, the authority of the frequency control unit is the OS, the power mode is Performance mode, the power mode flag is 4, and the power supply (1: ON, 0: OFF) is 1.

In addition, a server No. 3 is configured so that all resources (the number of CPU cores) are 32, the use resource 2 (performance priority) is 32, the total of use resources (the number of CPU cores) is 32, the idle resource (the number of CPU cores) is 0, the authority of the frequency control unit is the BIOS, the power mode is Performance mode, the power mode flag is 2, and the power supply (1: ON, 0: OFF) is 1.

In addition, a server No. 4 is configured so that all resources (the number of CPU cores) are 16, the use resource 1 (energy saving priority) is 10, the total of use resources (the number of CPU cores) is 10, the idle resource (the number of CPU cores) is 6, the frequency control unit is the OS, the power mode is Energy saving mode, the power mode flag is 3, and the power supply (1: ON, 0: OFF) is 1.

The server No. 5 is configured so that all resources (the number of CPU cores) are 32, the total of use resources (the number of CPU cores) is −, the idle resource (the number of CPU cores) is 32, the authority of the frequency control unit is the OS, the power mode is Energy saving mode, the power mode flag is 3, the power supply (ON: 1, 0: OFF) is 0.

In FIG. 2, the servers No. 1, No. 4, and No. 5 have the power mode of Energy saving mode indicating low power consumption, and the servers No. 2 and No. 3 have the power mode of Performance mode indicating high performance. Energy saving mode indicates a mode having a clock frequency control function by the DVFS of the server, and Performance mode indicates a mode having no clock frequency control function by the DVFS of the server. Hereinafter, in the figures, Energy saving mode is simply described as Energy saving, Performance mode is simply described as “Performance mode”. In addition, in the server No. 5, power supply is OFF.

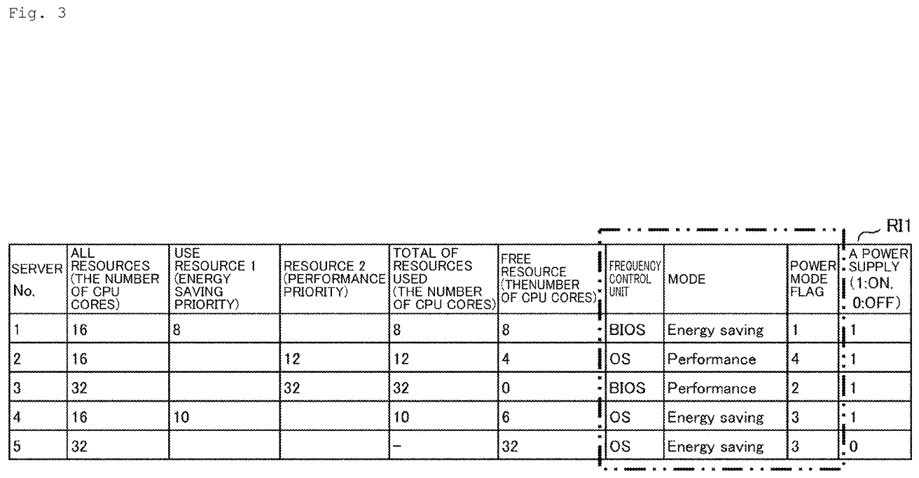

Next, the authority of the frequency control unit, the power mode, and the power mode flag in the resource information RI1 shown in FIG. 2 will be described with reference to FIG. 3.

FIG. 3 is an explanatory diagram for explaining the authority of the frequency control unit, the power mode, and the power mode flag.

The setting of validity/invalidity in the clock frequency control function by the DVFS of the server 31 can be set by either the BIOS or the OS. However, when the setting of the clock frequency control function is changed from the OS, it is necessary to set the BIOS beforehand so that the OS can acquire information on the combination of the clock frequency and the voltage called a performance state (P state).

When the authority of the frequency control unit is set in the BIOS, it is necessary to complete all tasks under processing on the server 31 once and to restart it, and therefore, it takes effort and time. The resource management unit 3 according to the present embodiment provides items related to power control, and selects a group of servers 31 with a power mode suitable for an optimization purpose as an arrangement destination candidate. At this time, an available server group can be preferentially set as a candidate of the arrangement destination server without changing the setting of the current power mode by saving the labor of setting the power mode and the time of restarting. Then, only when the resource is insufficient, the setting of the resource information is changed by the OS capable of changing the setting in a relatively short time.

For example, when the power mode flag of the resource information RI1 is 1, the authority of the frequency control is set in the BIOS, and the power mode is set in Energy saving mode (with a clock frequency control function). When the power mode flag of the resource information RI1 is 2, the authority of frequency control is set in the BIOS, and the power mode is set in Performance mode (without a clock frequency control function). When the power mode flag of the resource information RI1 is 3, the authority of frequency control is set in the OS, and the power mode is set in Energy saving mode (with a clock frequency control function). When the power mode flag of the resource information RI1 is 4, the authority of frequency control is set in the OS, and the power mode is set in Performance mode (without a clock frequency control function).

Energy saving mode (with a clock frequency control function), for example, changes the clock frequency of the server 31 according to the load of the application, and when the load of the application is large, the clock frequency of the server 31 is increased, when the load of the application is small, the clock frequency of the server 31 is decreased.

On the other hand, Performance mode (without a clock frequency control function) selects, as an example, the maximum frequency of the clock frequency of the server 31 regardless of the load of the application, and the server 31 always operates the fastest clock frequency.

### <Processing of Scheduler and Resource Management Unit of Present Embodiment>

Next, the processing of the scheduler 2 and the resource management unit 3 in the controller 10 of the virtual machine/container control system 100 according to the present embodiment will be described.

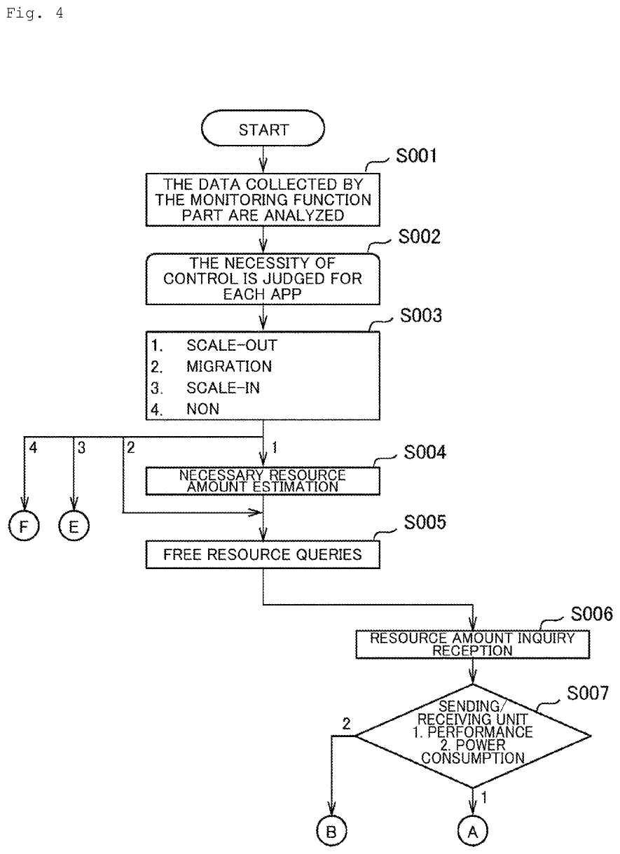

FIGS. 4 to 8 are flow charts showing the flow of scaling and migration processing executed by the scheduler 2 and the resource management unit 3 in the controller 10.

First, the monitor function unit 1 collects data indicating the state of the compute group 30, and transmits the collected data to the scheduler 2. The scheduler 2 acquires the data collected by the monitor function unit 1 and perms analysis of the data (step S001).

Next, the scheduler 2 determines the necessity of control for each application (App) to be executed in the virtual machine/container, and executes appropriate processing determined to be necessary among the processing 1. to 4. (step S002).

Specific processing of 1. To 4. is as follows.
<1. Scale-out>
<2. Migration>
<3. Scale-in>
<4. No Change>

Note that at the time of deployment, the same processing as the scale-out of the step S003 is executed by a request from the outside of the controller 10.

### <1. Scale-Out>

When executing scale-out, the scheduler 2 estimates a necessary resource amount for the virtual machine/container (step S004). Next, the scheduler 2 inquires of the resource management unit 3 about an idle resource (step S005).

The resource management unit 3 judges an optimization purpose of the optimization algorithm 21 to be executed by the scheduler 2(step S007) when receiving an inquiry about the idle resource amount from the scheduler 2 (step S006).

In this case, the resource management unit 3 acquires resource information from the resource database, and selects a server 31 corresponding to the optimization purpose of the optimization algorithm 21 from server information related to the server 31 described in the resource information on the basis of the predetermined server priority.

Here, the optimization purpose includes at least one purpose of performance and power consumption, when the optimization purpose gives priority to the power consumption, the resource management unit 3 selects a server 31 for changing the clock frequency of the virtual machine/container according to the load of the application and when the optimization purpose gives priority to the performance, the resource management unit 3 selects a server 31 for releasing the restriction for changing the clock frequency of the virtual machine/container according to the load of the application.

### <<Case of Performance Purpose>>

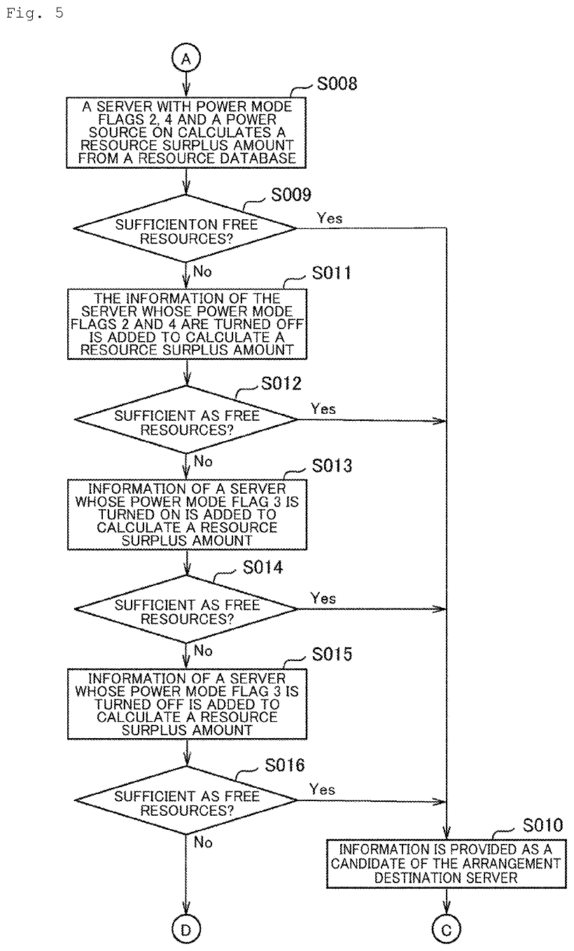

When the optimization algorithm 21 of the scheduler 2 is the performance purpose such as performance priority and performance guarantee priority (step S007, 1), the resource management unit 3 acquires resource information from the resource database of the storage 4 and calculate, a surplus amount of resources for the server 31 in which the item of (column) of power mode flag is 2 or 4 and power supply is ON (step S008 in FIG. 5).

That is, the resource management unit 3 selects a server 31 to be an arrangement destination candidate corresponding to the optimization purpose of the optimization algorithm 21 from a predetermined power mode according to a predetermined server priority.

In this case, the resource management unit 3 targets the server 31 in which the authority of frequency control is set in the BIOS and the power mode is Performance mode or the authority of frequency control is set to the OS and the power mode is set to Performance mode, and power supply is ON. That is, the resource management unit 3 indicates that the server 31 in which the power mode is set to Performance mode and power supply is ON is selected.

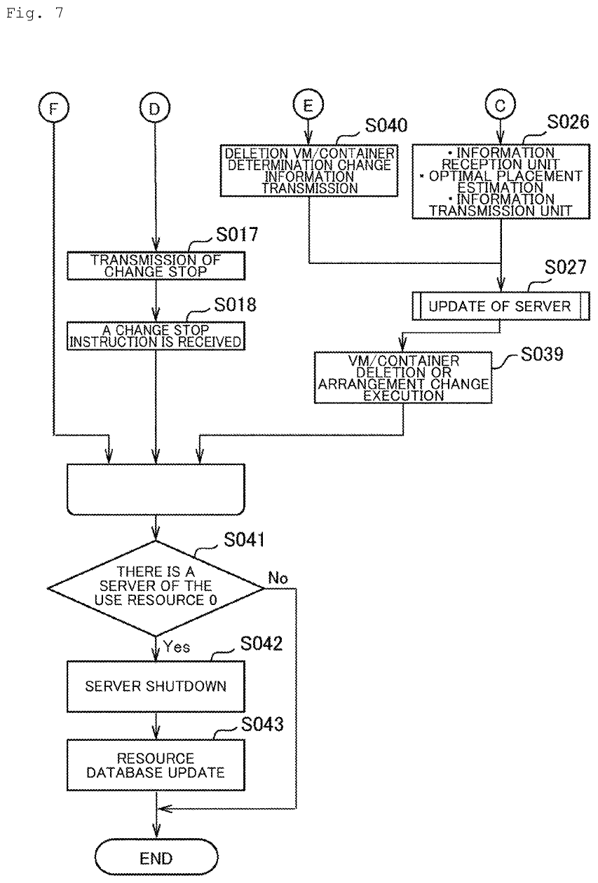

When the server 31 selected from the resource information is sufficient as the idle resource (Yes in step S009), the resource management unit 3 provides the scheduler 2 with server information on the server 31 in which the selected server 31 is a candidate of the arrangement destination server (step S010). Then, the controller 10 proceeds to step S026 (FIG. 7). Note that it is determined whether or not the resource is sufficient as the idle resource by, for example, whether or not the number of CPU cores is satisfied.

On the other hand, when the server 31 selected from the resource information is not sufficient as the idle resource (No in step S009), the resource management unit 3 adds, from the server information related to the server 31 described in the resource information, the server 31 in which the item (column) of the power mode flag is 2 or 4 and the power supply is OFF the resource, and calculates the surplus amount of the resource (step 011).

That is, when the setting of the power mode of the server 31 is given priority to Performance mode and the number of CPU cores is short in the server 31 in which the power supply is ON, the resource management unit 3 selects the server 31 in which the setting of the power mode of the server 31 is Performance mode and the power supply is OFF.

Thus, when selecting the server 31 from the same power mode, the resource management unit 3 selects the server in which the power supply is ON preferentially over the server in which the power supply is OFF.

When the server 31 selected again from the resource information is sufficient as the idle resource (Yes in step S012), the resource management unit 3 provides the scheduler 2 with server information on the server 31 in which the selected server 31 group is a candidate of the arrangement destination server (step 010). Then, the controller 10 proceeds to step S026 (FIG. 7).

On the other hand, when the server 31 selected again from the resource information is not sufficient as the idle resource (No in step S012), the resource management unit 3 adds, from the server information related to the server 31 described in the resource information, the server 31 in which the item (column) of the power mode flag is 3 and in which the power supply is ON to the resource and calculates the surplus amount of the resource (step S013).

That is, the resource management unit 3 adds the server 31 in which the authority of frequency control is set to the OS and the power mode is set to Energy saving mode, and the power supply is ON and calculates the resource surplus amount.

When the server 31 selected again from the resource information is sufficient as the idle resource (Yes in step S014), the resource management unit 3 provides the scheduler 2 with server information on the server 31 in which the added server 31 group is a candidate of the arrangement destination server (step S010). Then, the controller 10 proceeds to step S026 (FIG. 7).

On the other hand, when the server 31 selected again from the resource information is not sufficient as the idle resource (No in step S014), the resource management unit 3 adds, from the server information related to the server 31 described in the resource information, the server 31 in which the item (column) of the power mode flag is 3 and the power supply is OFF to the resource, and calculates the surplus amount of the resource (step S015).

That is, the resource management unit 3 adds the server 31 in which the authority of frequency control is set to the OS and the power mode is set to Energy saving mode, and the power supply is OFF and calculates the surplus resource amount.

In this way, when selecting the server from the same power mode, the resource management unit 3 selects the server in which the power supply is ON preferentially over the server in which the power supply is OFF.

When the server 31 selected again from the resource information is sufficient as the idle resource (Yes in step S016), the resource management unit 3 provides the scheduler 2 with server information on the server 31 in which the added server 31 group is a candidate of the arrangement destination server (step S010). Then, the controller 10 proceeds to step S026 (FIG. 7).

On the other hand, when the server 31 selected from the resource information again is not sufficient resource as the idle resource (No in step S016), the resource management unit 3 proceeds to step S017 (FIG. 7), and transmits an instruction of change stop indicating that scale-out cannot be executed to the scheduler 2.

When receiving the instruction of change stop indicating that scale-out cannot be executed from the resource management unit 3 (step S018), the scheduler 2 returns to the step S002 to determine the necessity of control for each application.

### <<Case of Power Consumption Purpose>>

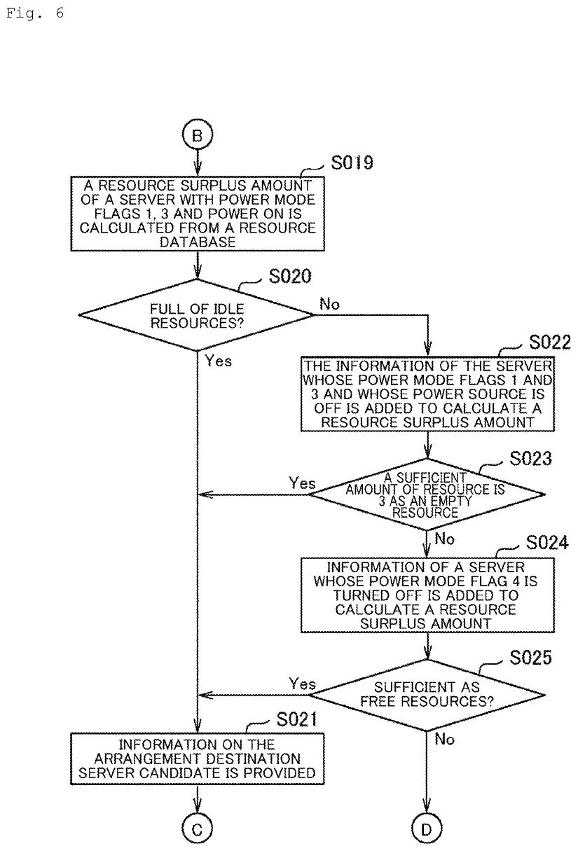

When the optimization algorithm 21 of the scheduler 2 is a power consumption purpose such as power consumption reduction and energy saving (step S007, 2), the resource management unit 3 acquires resource information from the resource database of the storage 4, and calculates the surplus resource amount to the server 31 in which the item (column) of the power mode flag is 1 or 3 and in which the power supply is ON (step S019 in FIG. 6).

That is, the resource management unit 3 selects the server 31 to be the arrangement destination candidate corresponding to the optimization purpose of the optimization algorithm 21 from a predetermined power mode according to a predetermined server priority.

In this case, the resource management unit 3 targets the server 31 in which the authority of frequency control is set in the BIOS and the power mode is Energy saving mode or the authority of frequency control is set to the OS and the power mode is set to Energy saving mode, and power supply is ON. That is, the resource management unit 3 indicates that the server 31 in which the power mode is set to Energy saving mode and in which the power supply is ON is selected.

When the server 31 selected from the resource information is sufficient as the idle resource (Yes in step S020), the resource management unit 3 provides the scheduler 2 with server information on the server 31 in which the selected server 31 group is a candidate of the arrangement destination server (step S021). The determination as to whether or not the resource is sufficient as the idle resource can be determined by, for example, whether or not the number of CPU cores is satisfied, as in Performance mode. Then, the controller 10 proceeds to step S026 (FIG. 7).

On the other hand, when the server 31 selected from the resource information is not sufficient as the idle resource (No in step S020), the resource management unit 3 adds, from the server information on the server 31 described in the resource information, the server 31 in which the item (column) of the power mode flag is 1 or 3 and in which the power supply is OFF to the resource, and calculates the surplus resource amount (step S022).

That is, when the setting of the power mode of the server 31 is prioritized to be Energy saving mode and the number of CPU cores is short in the server 31 in which the power supply is ON, the resource management unit 3 selects the server 31 in which the setting of the power mode is Energy saving mode and power supply is OFF.

In this way, when selecting the server from the same power mode, the resource management unit 3 selects the server in which the power supply is ON preferentially over the server in which the power supply is OFF.

When the server 31 selected again from the resource information is sufficient as the idle resource (Yes in step S023), the resource management unit 3 provides the scheduler 2 with server information on the server 31 in which the selected server 31 group is a candidate of the arrangement destination server (step S021). Then, the controller 10 proceeds to step S026 (FIG. 7).

On the other hand, when the server 31 selected again from the resource information is not sufficient as the idle resource (No in step S023), the resource management unit 3 adds, from the server information on the server 31 described in the resource information, the server 31 in which the item (column) of the power mode flag is 4 and the power supply is OFF to the resource, and calculates the surplus resource amount (step S024).

That is, the resource management unit 3 adds the server 31 in which the authority of frequency control is set to the OS and the power mode is set to Performance mode, and the power supply is OFF and calculates the surplus resource amount.

Here, when the server 31 in which the power mode is set to Performance mode is added to a target in a state where the power supply is ON, the state of the server 31 may be changed, and the performance of the existing application may be degraded.

Therefore, in the case of the power mode in which power consumption is prioritized, the resource management unit 3 does not select the server 31 in which the power supply is ON and the performance is prioritized so as to be the arrangement destination candidate server. Thus, even if the power mode is set to Performance mode, the resource management unit 3 does not affect the performance of the existing application if the server 31 in which the power supply is OFF is selected.

When the server 31 selected again from the resource information is sufficient as the idle resource (Yes in step S025), the resource management unit 3 provides the scheduler 2 with server information on the server 31 in which the added server 31 group is a candidate of the arrangement destination server (step S021). Then, the controller 10 proceeds to step S026 (FIG. 7).

On the other hand, when the server 31 selected from the resource information again is not sufficient resource as the idle resource (No in step S025), the resource management unit 3 proceeds to step S017 (FIG. 7), and transmits an instruction of change stop indicating that scale-out cannot be executed to the scheduler 2. The subsequent processing is the same as above.

In step S026, the scheduler 2 receives server information from the resource management unit 3. Then, the scheduler 2 executes the optimization algorithm 21 for the server 31 group satisfying the request in the received server information, and executes the optimal arrangement estimation. Then, the scheduler 2 transmits the change information of the server 31 to the resource management unit 3. The change information of the server 31 means that change information is information for changing the state of the server 31 by the optimal arrangement estimation.

### <<Update of Server>>

The resource management unit 3 receives the change information of the server 31 from the scheduler 2, starts the server 31 and changes the power mode as necessary, and updates the resource information of the resource database stored in the storage 4 (step S027).

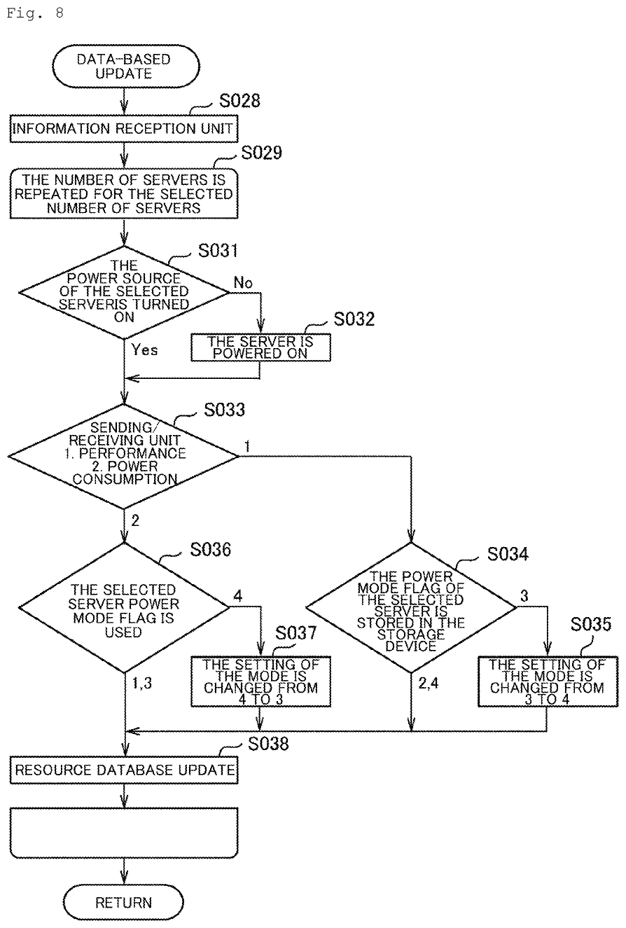

In step S027, when receiving the change information of the servers 31 from the scheduler 2 (step S028), as shown in FIG. 8, the resource management unit 3 repeats the following processing to all of the number of selected server 31 (step S029).

The resource management unit 3 judges whether or not the power supply of the server 31 selected in the change information received from the scheduler 2 is ON (step S031), and proceeds to step S033 when the power supply of the server 31 is ON (Yes in step S031). On the other hand, when the power supply of the server 31 is OFF (No in step S031), the resource management unit 3 turns on the power supply of the server 31 (step S032) and proceeds to step S033.

Next, the resource management unit 3 judges whether the optimization purpose of the selected server 31 is the performance purpose or the power consumption purpose (step S033), and proceeds to step S034 when the optimization purpose is the performance purpose (step S033,1).

The resource management unit 3 judges the power mode flag of the selected server 31 (step S034), and changes the setting of the power mode from 3 to 4 (step S035), and proceeds to step S038, when the power mode flag is 3 (step S034, 3). On the other hand, when the power mode flag is 2 or 4 (step S034, 2, 4), the resource management unit 3 proceeds to step S038.

On the contrary, when the optimization purpose of the selected server 31 is the power consumption purpose (step S033, 2), the resource management unit 3 advances to step S036.

The resource management unit 3 judges the power mode flag of the selected server 31 (step S036), and changes the setting of the power mode from 4 to 3 (step S037), and proceeds to step S038, when the power mode flag is 4 (step S034, 4). On the other hand, when the power mode flag is 1 or 3 (step S036, 1, 3), the resource management unit 3 proceeds to step S038.

Thus, the resource management unit 3 can change the power mode of the server 31 group on the basis of the change information of the server 31 received from the scheduler 2.

When the resource management unit 3 updates resource information of the resource database stored in the storage 4 (step S038), the resource management unit 3 sequentially repeats the processing by the number of servers 31 for the other selected server 31 to which the processing is not performed (step S029).

Thus, the resource management unit 3 can update the resource information of the resource database stored in the storage 4(step S038). Then, the controller 10 proceeds to step S039 (FIG. 7).

When the update of the server 31 is completed (step S027 in FIG. 7), the scheduler 2 deletes the virtual machine/container or changes the arrangement (step S039), and terminates the processing of scale-out (see FIG. 4).

### <2. Migration>

Next, a migration of FIG. 4 will be described. When executing the migration, the scheduler 2 does not estimate the necessary resource amount of the step S004, proceeds to the step S005, and executes an inquiry about the idle resource (step S005). For other processing, the same processing as the scale-out processing is executed.

### <3. Scale-In>

Next, a scale-in of FIG. 4 will be described. When executing the scale-in, the scheduler 2 proceeds to step S040 in FIG. 7, determines a virtual machine/container to be deleted, and transmits change information of the server 31 to the resource management unit 3. Thereafter, processing after step S027 is executed.

### <4. No Change>

In the step S003 of FIG. 4, the scheduler 2 determines the necessity of control of a certain application, and returns to the step S002 and repeats the determination of necessity of control for other application when it is not necessary to change the virtual machine/container.

When the determination of the necessity of the control of the virtual machine/container for each application is terminated, the processing proceeds to step S041 of FIG. 7.

When there is the server 31 in which the use resource is 0 (Yes in step S041), the resource management unit 3 shuts down the server 31 (step S042), updates the resource information of the resource database stored in the storage 4 (step S043), and terminates processing of the scheduler 2 and the resource management unit 3.

That is, the resource management unit 3 turns off the power supply to the server 31 which is not used as the resource among the servers 31 indicated by the resource information.

On the other hand, when there is no server 31 in which the use resource is 0 in the resource information (No in step S041), the scheduler 2 and the resource management unit 3 terminate the processing.

### <Selection of Candidate of Arrangement Destination Server and Optimal Arrangement Estimation>

Next, in step S010 of FIG. 5, an example of providing server information on the server 31 as a candidate of the arrangement destination server is described. Note that, as an example, regarding an example in the case of deployment (scale-out) of FIG. 4 and in the case where the application (performance purpose) giving priority to performance is selected in step S007, the following description will be made. Note that it is assumed that 30 CPU cores are required as the idle resources.

First, the resource management unit 3 acquires resource information from the resource database of the storage 4.

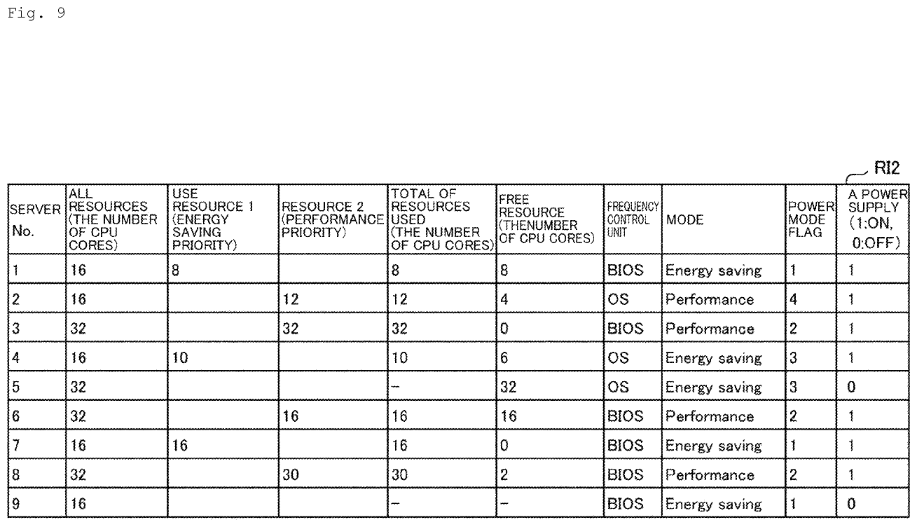

FIG. 9 is an explanatory diagram showing the resource information RI2 acquired from the resource database of the storage 4. Note that the item (column) described in the resource information RI2 is the same item (column) as that in FIG. 2, and in FIG. 9, No. 1 to No. 9 are described as the server 31.

For example, a server No. 1 is configured so that all resources (the number of CPU cores) are 16, the use resource 1 (energy saving priority) are 8, the total of use resources (the number of CPU cores) is 8, the idle resource (the number of CPU cores) is 8, the authority of the frequency control unit is the BIOS, the power mode is Energy saving mode, the power mode flag is 1, and the power supply (1: ON, 0: OFF) is 1.

In addition, a server No. 2 is configured so that all resources (the number of CPU cores) are 16, the use resource 2 (performance priority) is 12, the total of use resources (the number of CPU cores) is 12, the idle resource (the number of CPU cores) is 4, the authority of the frequency control unit is the OS, the power mode is Performance mode, the power mode flag is 4, and the power supply (1: ON, 0: OFF) is 1.

In addition, a server No. 3 is configured so that all resources (the number of CPU cores) are 32, the use resource 2 (performance priority) is 32, the total of use resources (the number of CPU cores) is 32, the idle resource (the number of CPU cores) is 0, the authority of the frequency control unit is the BIOS, the power mode is Performance mode, the power mode flag is 2, and the power supply (1: ON, 0: OFF) is 1.

In addition, a server No. 4 is configured so that all resources (the number of CPU cores) are 16, the use resource 1 (energy saving priority) is 10, the total of use resources (the number of CPU cores) is 10, the idle resource (the number of CPU cores) is 6, the authority of the frequency control unit is the OS, the power mode is Energy saving mode, the power mode flag is 3, and the power supply (1: ON, 0: OFF) is 1.

In addition, a server No. 5 is configured so that all resources (the number of CPU cores) are 32, the total of use resources (the number of CPU cores) is −, the idle resource (the number of CPU cores) is 32, the authority of the frequency control unit is the OS, the power mode is Energy saving mode, the power mode flag is 3, and the power supply (0: ON, 0: OFF) is 1.

In addition, a server No. 6 is configured so that all resources (the number of CPU cores) are 32, the use resource 2 (performance priority) is 16, the total of use resources (the number of CPU cores) is 16, the idle resource (the number of CPU cores) is 16, the authority of the frequency control unit is the BIOS, the power mode is Performance mode, the power mode flag is 2, and the power supply (1: ON, 0: OFF) is 1.

In addition, a server No. 7 is configured so that all resources (the number of CPU cores) are 16, the use resource 1 (energy saving priority) is 16, the total of use resources (the number of CPU cores) is 16, the idle resource (the number of CPU cores) is 0, the authority of the frequency control unit is the BIOS, the power mode is Energy saving mode, the power mode flag is 1, and the power supply (1: ON, 0: OFF) is 1.

In addition, a server No. 8 is configured so that all resources (the number of CPU cores) are 32, the use resource 2 (performance priority) is 30, the total of use resources (the number of CPU cores) is 30, the idle resource (the number of CPU cores) is 2, the authority of the frequency control unit is the BIOS, the power mode is Performance mode, the power mode flag is 2, and the power supply (1: ON, 0: OFF) is 1.

In addition, a server No. 9 is configured so that all resources (the number of CPU cores) are 16, the authority of the frequency control unit is the BIOS, the power mode is Energy saving mode, the power mode flag is 1, and the power supply (0: ON, 0: OFF) is 1.

In this case, the resource management unit 3 executes processing from step S008 to step S016 of FIG. 5 to the resource information RI2 of FIG. 9. That is, the resource management unit 3 first adds the server in which the power mode is Performance mode to the selection of the candidate of the arrangement destination server in the order of ON/OFF of the power supply as the priority (the predetermined priority) of the server 31, and determines whether or not the idle resource is sufficient.

When the idle resource is not sufficient, the server in which the authority of the frequency control unit is the OS and the power mode is Energy saving mode is added to the selection of the candidate of the arrangement destination server in the order of ON/OFF of the power supply, and it is determined whether or not the idle resource is sufficient. Thus, the resource management unit 3 judges whether or not 30 or more idle resources of the CPU core can be secured.

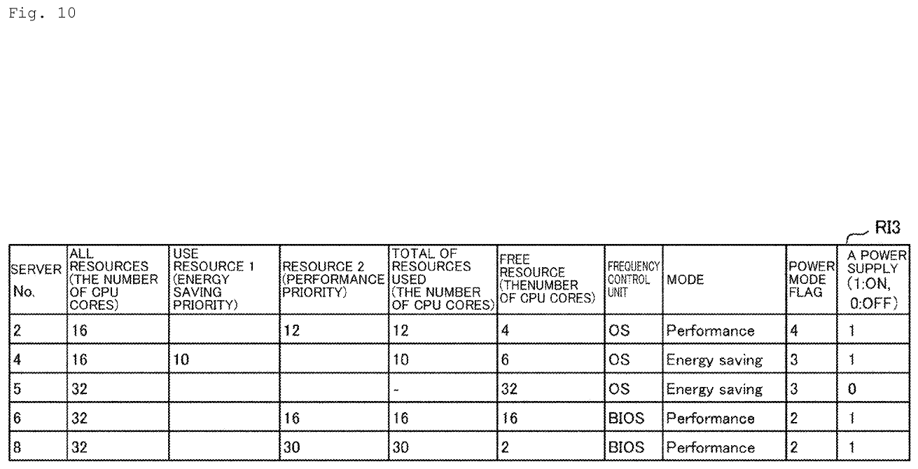

In the case of the resource information RI2 in FIG. 9, the servers No. 1, No. 7, and No. 9 have the BIOS authority of the frequency control unit, and since the power mode is Energy saving mode, these servers are excluded from the candidate of the arrangement destination server. In addition, since there is no idle resource, the server No. 3 is excluded from the candidate of the arrangement destination server. As a result, the candidate of the destination server is selected as shown in FIG. 10.

FIG. 10 shows resource information RI3 (selection information) in which the servers 31 are selected as candidates for the arrangement destination servers from the resource information RI2 shown in FIG. 9.

As shown in FIG. 10, in the resource information RI3, the servers No. 2, No. 4, No. 5, No. 6 and No. 8 are selected. In the resource information RI3, since the total of the idle resources of the CPU cores is 60, the resource request is satisfied. Therefore, the resource management unit 3 transmits the resource information RI3 (the selection information) to the scheduler 2 as a candidate of the arrangement destination server (step S010 in FIG. 5).

The scheduler 2 executes, for example, the optimal arrangement estimation of the optimization algorithm 21 on the basis of the received resource information RI3 (the selection information) (refer to step S026 in FIG. 7).

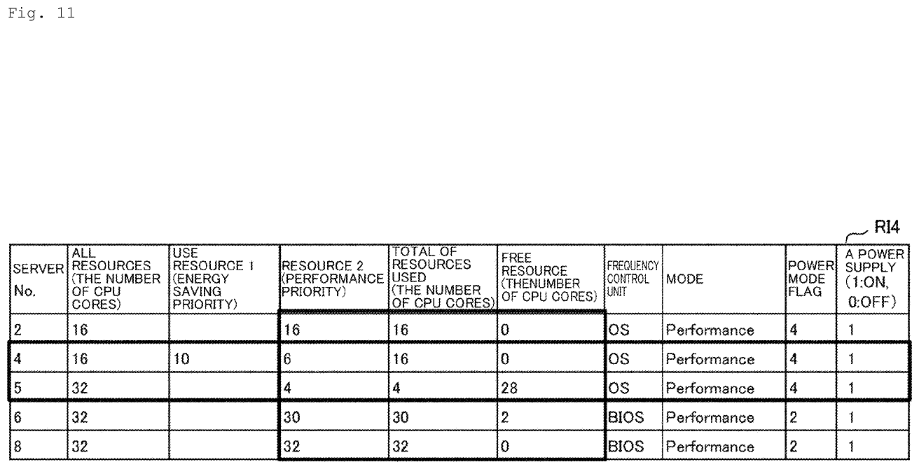

FIG. 11 is resource information RI4 showing the result of execution of the optimal arrangement estimation for the server 31 of the resource information RI3 shown in FIG. 10.

As shown in FIG. 11, in the resource information RI4, the power mode of the servers No. 4 and No. 5 is changed from Energy saving mode to Performance mode. In the server No. 5, the power mode is changed and the power supply is changed from OFF to ON.

In the resource information RI4, since the optimal arrangement estimation of the optimization algorithm 21 is executed for the purpose of performance priority, the resources 2 (performance priority) used for all servers No. 2 to No. 8 of the servers are changed. Thus, in the resource information RI4, the use resources 2 (performance priority) of all servers No. 2 to No. 8 of the servers are changed, and the total of use resources (the number of CPU cores) and the idle resources (the number of CPU cores) of each server are changed.

More specifically, for the server No. 2, the resource 2 (performance priority) is changed from 12 to 16, the total of use resources (the number of CPU cores) is changed from 12 to 16, and the idle resource (the number of CPU cores) is changed from 4 to 0.

In addition, for the server No. 4, the use resource 2 (performance priority) is changed from no to 6, the total of use resources (the number of CPU cores) is changed from 10 to 16, the idle resource (the number of CPU cores) is changed from 6 to 0.

In addition, for the server No. 5, the use resource 2 (performance priority) is changed from no to 4, the total of use resources (the number of CPU cores) is changed from no to 4, and the idle resource (the number of CPU cores) is changed from 32 to 28.

In addition, for the server No. 6, the use resource 2 (performance priority) is changed from 16 to 30, the total of use resources (the number of CPU cores) is changed from 16 to 30, and the idle resource (the number of CPU cores) is changed from 16 to 2.

In addition, for the server No. 8, the use resource 2 (performance priority) is changed from 30 to 32, the total of use resources (the number of CPU cores) is changed from 30 to 32, and the idle resource (the number of CPU cores) is changed from 2 to 0.

Then, the scheduler 2 transmits the result of the optimal arrangement estimation (resource information RI4) to the resource management unit 3 as the change information of the server 31 (see step S026 in FIG. 7).

When receiving the resource information RI4 as the change information of the server 31, the resource management unit 3 updates the server 31 (step S027 in FIG. 7). The resource management unit 3 changes the setting of the power mode flag corresponding to the power supply of each server 31 and the optimization purpose on the basis of the resource information RI4, updates the resource database of the storage 4, and obtains resource information RI5 (step S038 in FIG. 8).

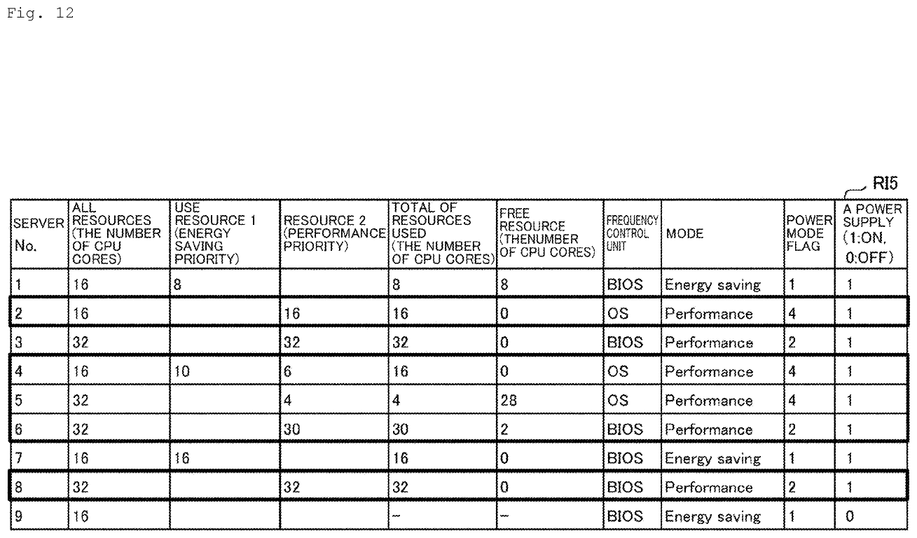

FIG. 12 is an explanatory diagram showing the resource information RI5 obtained by updating the resource information RI2 (see FIG. 9) based on the resource information RI4 by the resource management unit 3.

As shown in FIG. 12, the resource information RI5 reflects the result of the execution of the optimal arrangement estimation shown in FIG. 11 with respect to the resource information RI2 shown in FIG. 9.

In FIG. 12, the servers No. 1, No. 3, No. 7, and No. 9 are in the state of the resource information RI2 shown in FIG. 2, the servers No. 2, No. 4, No. 5, No. 6, and No. 8 are updated to the content of the resource information RI4 shown in FIG. 11.

Although FIG. 12 has been described in the case where the optimization algorithm 21 is executed by applying the application (performance purpose) giving priority to performance to the resource information RI2 shown in FIG. 9, the present invention is not limited to this, and the present invention can be applied to the application (power consumption purpose) which gives priority to power consumption.

As described above, the controller 10 of the virtual machine/container control system 100 according to the present embodiment acquires the resource information from the resource database of the storage 4 by the resource management unit 3, and selects the server 31 corresponding to the optimization purpose of the optimization algorithm 21 from the server information related to the server 31 described in the resource information on the basis of the predetermined server priority.

Thus, the scheduler 2 executes the optimization algorithm to the server 31 selected by the resource management unit 3 on the basis of the predetermined server priority, and can execute the optimal arrangement estimation of the virtual machine/container.

### <Hardware Configuration of Controller>

The controller 10 according to a first embodiment is realized by, for example, a computer 900 having a configuration as shown in FIG. 13.

FIG. 13 is a hardware configuration diagram showing an example of the computer 900 that realizes the functions of the controller 10 according to the first embodiment.

The computer 900 includes a CPU (Central Processing Unit) 901, a ROM (Read Only Memory) 902, a RAM (Random Access Memory) 903, an HDD (Hard Disk Drive) 904, an input/output I/F (Interface) 905, a communication I/F 906, and a media I/F 907.

The CPU 901 operates on the basis of a program stored in the ROM 902 or the HDD 904, and functions as the monitor function unit 1, the scheduler 2, and the resource management unit 3 shown in FIG. 1.

The ROM 902 stores a boot program executed by the CPU 901 when the computer 900 is started, a program related to the hardware of the computer 900, and the like.

The CPU 901 controls an input device 910 such as a mouse and a keyboard and an output device 911 such as a display, via the input/output I/F 905. The CPU 901 acquires data from the input device 910 and outputs generated data to the output device 911, via the input/output I/F 905. Note that a GPU or the like may be used together with the CPU 901 as the processor.

The HDD 904 stores a program executed by the CPU 901, data used by the program, and the like. The communication I/F 906 receives data from another device via a communication network (e.g., a NW (network) 920) and outputs the data to the CPU 901, and transmits the data generated by the CPU 901 to the other device via the communication network.

The media I/F 907 reads a program or data stored in a recording medium 912 and outputs the program or data to the CPU 901 via the RAM 903. The CPU 901 loads a program related to the target processing from the recording medium 912 onto the RAM 903 via the media I/F 907, and executes the loaded program. The recording medium 912 is an optical recording medium such as a DVD (Digital Versatile Disc) or PD (Phase change rewritable Disk), a magneto-optical recording medium such as a MO (Magneto Optical disk), a magnetic recording medium, a conductor memory tape medium, a semiconductor memory, or the like.

For example, when the computer 900 functions as the controller 10 according to the first embodiment, the CPU 901 of the computer 900 realizes the monitor function unit 1, the scheduler 2, and the resource management unit 3 by executing the program loaded on the RAM 903.

The data in the RAM 903 is stored in the HDD 904. The CPU 901 reads a program related to the target processing from the recording medium 912 and executes the program. In addition, the CPU 901 may read a program related to the target processing from another device via the communication network (NW 920).

Next, the difference between the effects of the virtual machine/container control system 100 according to the present embodiment and the prior art will be described by comparing with the prior art.

### Comparative Example

In the prior art as a comparative example, the controller executes the optimal arrangement estimation by the optimization algorithm and executes the arrangement control of the server. However, in the prior art, the resource management unit cannot set the energy saving mode or select the idle resource.

For this reason, even when, for example, the application requires 10 CPU cores, the conventional resource management unit has selected all servers as candidates for the destination server.

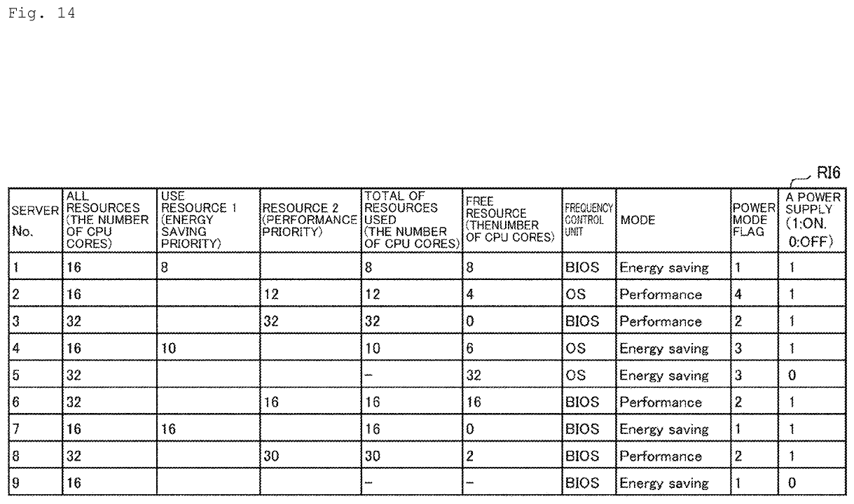

FIG. 14 shows resource information RI6 showing a server which is the arrangement destination candidate at the time of the optimal arrangement estimation. In FIG. 14, the resource information RI2 shown in FIG. 9 will be described as an example.

In the conventional controller, since a resource management unit cannot select the energy saving mode or the idle resource, when executing optimal arrangement estimation by the optimization algorithm, all the servers (servers No. 1 to No. 9) in FIG. 14 are targeted for the candidate of the arrangement destination server by a scheduler.

On the other hand, the controller 10 according to the present embodiment causes the resource management unit 3 to selects the server 31, from the server information related to the server 31 described in the resource information, corresponding to the optimization purpose of the optimization algorithm 21 on the basis of the predetermined server priority. First, the case where the optimal arrangement estimation of the optimization algorithm 21 is executed for an application in which the performance is given priority will be described.

For example, the controller 10 according to the present embodiment acquires the resource information RI6 (see FIG. 14) by the resource management unit 3, and selects the server in which the power mode is Performance mode as a candidate for the arrangement destination server.

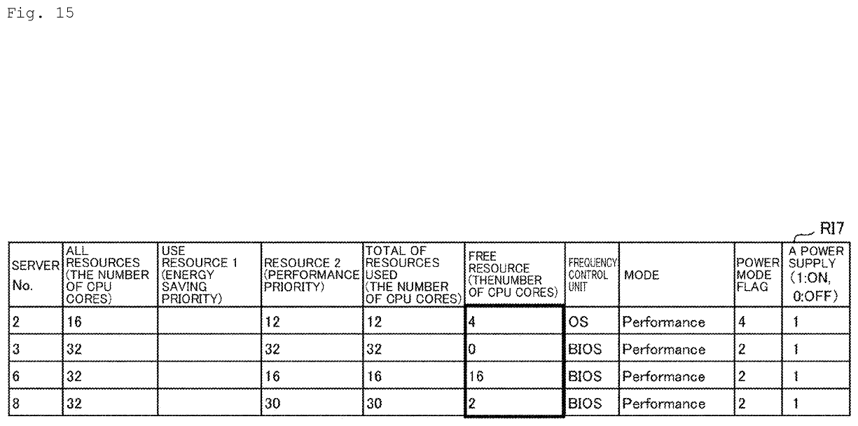

FIG. 15 is an explanatory diagram showing resource information RI7 in which the resource management unit 3 selects the server in which the power mode is Performance mode as a candidate for the arrangement destination server from the resource information RI6.

The resource management unit 3 selects the servers No. 2, No. 3, No. 6 and No. 8 as a candidate of the arrangement destination server from the resource information RI6 shown in FIG. 14, and provides the scheduler 2 with the information on these servers 31 as the server information. In this case, since the total of the idle resources (the number of CPU cores) is 22, the request of 10 which is a resource request of the application is satisfied.

In this way, the scheduler 2 can prevent the server 31 in which the power mode is Performance mode from being changed to Energy saving mode, so that performance degradation can be prevented.

Next, the case where the optimal arrangement estimation of the optimization algorithm 21 is executed for an application in which the power consumption is prioritized will be described.

Similarly, in the case of giving priority to power consumption, since the conventional controller cannot select the energy saving mode or the idle resource, when the scheduler executes the optimal arrangement estimation by the optimization algorithm, all the servers (servers No. 1 to No. 9 of FIG. 14) are targeted for the candidate of the destination server.

On the other hand, the controller 10 according to the present embodiment can set the server 31 satisfying a resource request while giving priority to power consumption, for example, when the resource request of the application requests 10 CPU cores, the resource management unit 3 selects the server in which the power mode is the energy saving mode as a candidate of the arrangement destination server from the resource information RI6 (see FIG. 14). Note that, here, it is assumed that the resource management unit 3 preferentially selects the server in which the power supply is ON.

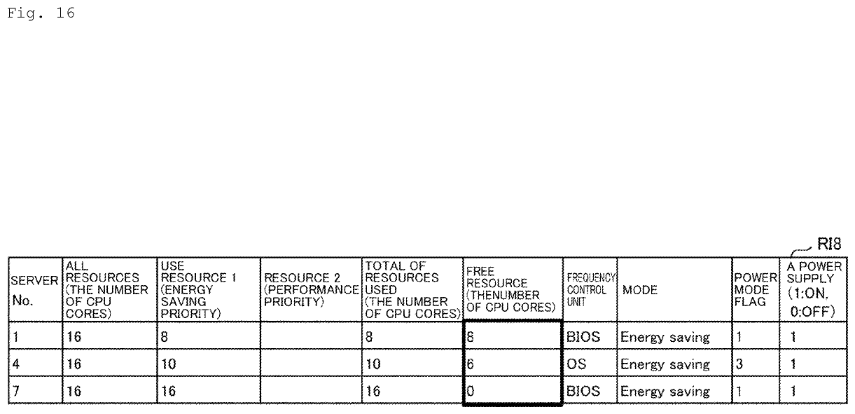

FIG. 16 is an explanatory diagram showing resource information RI8 in which the resource management unit 3 selects the server 31 in which the power mode is Energy saving mode as a candidate of the arrangement destination server from the resource information RI6.

The resource management unit 3 selects the servers No. 1, No. 4, and No. 7 as candidates of the arrangement destination server, and can provide the scheduler 2 with the information related to these servers 31 as the server information. In this case, since the total of the idle resources (the number of CPU cores) is 14, the request of 10, which is the resource request of the application, is satisfied.

Thus, the scheduler 2 can prevent the power mode from being changed to Performance mode by setting the server 31 in which the power mode is Energy saving mode as a candidate of the arrangement destination server even in the optimal arrangement estimation for the purpose of the energy saving mode.

In addition, for example, when the resource request of the application is 20 CPU cores, since the resource management unit 3 can set the priority by turning ON/OFF the power supply of the server in which the power mode is Energy saving mode, the server in which the power supply is OFF can be set as the server which is the next candidate of the server in which the power supply is ON.

Thus, when the CPU core is short in response to the resource request of the application, the resource management unit 3 can select the server in which the power supply is OFF as a candidate destination server next to the server in which the power supply is ON, and the arrangement of the servers 31 can be aggregated.

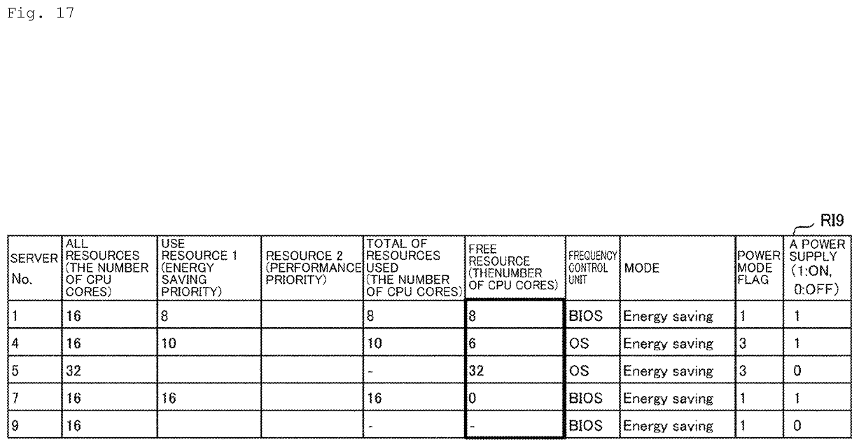

FIG. 17 is an explanatory diagram showing resource information RI9 in which the resource management unit 3 selects the server in which the power mode is Energy saving mode as a candidate of the arrangement destination server and adds the server in which the power supply is OFF to the selection of the candidate from the resource information RI6 (FIG. 14).

In the resource information RI9 shown in FIG. 17, the servers No. 5 and No. 9 in which the power mode is Energy saving mode and the power supply is OFF are added to the resource information RI8 shown in FIG. 16. When the resource request of the application is 20 CPU cores, the resource management unit 3 selects the server No. 5 in which the power supply is OFF in order to compensate for the shortage of the CPU cores. Thus, the scheduler 2 can select the server 31 satisfying the performance while maintaining the energy saving mode.

In this case, the scheduler 2 adds the server No. 5 to the candidate destination server and executes the optimal arrangement estimation of the optimization algorithm 21, thereby satisfying the request of performance without starting the server No. 9. In this way, the scheduler 2 can suppress unnecessary start of the server and maintain the energy saving mode.

### Effects

Effects of the controller 10 according to the present embodiment will be described below.

(1) The controller 10 is characterized in that the controller 10 includes the monitor function unit 1 that collects data indicating a state of the compute group 30 having a plurality of servers 31 for realizing a plurality of types of virtual machines/containers as computes, a storage 4 that stores resource information indicating resources of the plurality of types of virtual machines/containers in the database, the scheduler 2 selects the optimization algorithm 21 corresponding to each application to be executed in the virtual machine/container on the basis of the data together with acquiring the data collected by the monitor function unit 1 and the resource management unit 3 that acquires resource information from the database and selects the server 31 corresponding to the optimization purpose of the optimization algorithm from the server information related to the server 31 described in the resource information on the basis of the predetermined server priority, and the scheduler 2 executes the optimization algorithm 21 to the server 31 selected by the resource management unit 3 on the basis of the predetermined server priority, and executes the optimal arrangement estimation of the virtual machine/container.

Thus, the controller 10 acquires the resource information from the resource database in the resource management unit 3, and can select the server 31 corresponding to the optimization purpose of the optimization algorithm 21 from the server information related to the server 31 described in the resource information on the basis of the predetermined server priority. Then, the controller 10 executes the optimization algorithm 21 to the server 31 selected by the resource management unit 3 on the basis of the predetermined server priority in the scheduler 2, and can execute the optimal arrangement estimation of the virtual machine/container.

Therefore, the controller 10 can reduce power consumption as a whole data center while satisfying individual performance requirements of the application.

In particular, the resource management unit 3 manages the setting of energy saving of the server 31, thereby guaranteeing the performance of an application having high performance requirement. In addition, the resource management unit 3 can control the amount and setting of physical resources to be used on the basis of the predetermined priority in addition to the optimal arrangement estimation by the scheduler 2, so that the power saving of the data center can be realized.

(2) The controller 10 in (1) is characterized in that the controller 10, in the resource management unit 3, selects the server 31 to be the arrangement destination candidate corresponding to the optimization purpose of the optimization algorithm 21 from the predetermined power mode on the basis of the predetermined server priority.

Thus, in the resource management unit 3, the controller 10 executes the selection of the server 31 group in accordance with the optimization purpose of the optimization algorithm 21 from the predetermined power mode.

(3) The controller 10 in (2) is characterized in that when selecting the server 31 from the same power mode, the controller 10, in the resource management unit 3, selects the server 31 in which the power supply is ON preferentially over the server in which the power supply is OFF, and does not select the server 31 in which the power supply is ON and the performance is prioritized as the server to be the arrangement destination candidate in the case of the power mode in which power consumption is prioritized.

Thus, the controller 10 can select the server 31 in which the power supply is ON preferentially over the server 31 in which the power supply is OFF for each power mode. In addition, in the case of the power mode in which power consumption is prioritized, since the controller 10 does not select the server 31 in which the power supply is ON and the performance is prioritized as the server to be the arrangement destination candidate, and unintended change of the power mode of the server 31 can be prevented.

(4) The controller 10 according to any one of (1) to (3) is characterized in that the controller 10, in the resource management unit 3, turns off the power supply to the server 31 not used as a resource among the servers 31 indicated in the resource information.

Thus, the controller 10 can suppress the power consumption.

(5) The controller 10 according to any one of (1) to (4) is characterized in that the optimization purpose includes at least one purpose of performance and power consumption, and when the optimization purpose prioritizes the power consumption, the resource management unit 3 selects the server 31 for changing the clock frequency of the virtual machine/container in accordance with the load of the application, and when the optimization purpose prioritizes the performance, the resource management unit 3 selects the server 31 for releasing the restriction for changing the clock frequency of the virtual machine/container in accordance with the load of the application.

Thus, the controller 10 can select, in the resource management unit 3, the server 31 for changing the clock frequency of the virtual machine/container or the server 31 for releasing the restriction for changing the clock frequency of the virtual machine/container in accordance with the optimization purpose, so that the optimization purpose can be achieved.

(6) A resource allocation update method is characterized in that the resource allocation update method executes a step in which the resource allocation update device collects data indicating a state of a compute group 30 having a plurality of servers 31 for realizing a plurality of types of virtual machines/containers as computes, a step of storing resource information indicating resources of the plurality of types of virtual machines/containers in the resource database, a step of acquiring the collected data and selecting the optimization algorithm 21 corresponding to each application to be executed in the virtual machine/container on the basis of the data, a step of acquiring the resource information from the resource database and selecting the server 31 corresponding to the optimization purpose of the optimization algorithm 21 from server information related to the server 31 described in the resource information on the basis of the predetermined server priority, and a step of executing the optimization algorithm 21 to the server 31 selected on the basis of the predetermined server priority and executing the optimal arrangement estimation of the virtual machine/container.

Thus, the resource allocation update method acquires the resource information from the resource database and can select the server 31 corresponding to the optimization purpose of the optimization algorithm 21 from the server information related to the server 31 described in the resource information on the basis of the predetermined server priority. Then, the resource allocation update method can execute the optimization algorithm 21 to the server 31 selected on the basis of the predetermined server priority, and can execute the optimal arrangement estimation of the virtual machine/container.

Thus, the resource allocation update method can reduce power consumption as a whole data center while satisfying individual performance requirements of the application.

(7) A program is characterized in that the program causes a computer to execute a procedure for collecting data indicating a state of the compute group 30 having a plurality of servers 31 for realizing a plurality of types of virtual machines/containers as computes, a procedure for storing resource information indicating resources of the plurality of types of virtual machines/containers in the resource database, a procedure for acquiring the collected data and selecting the optimization algorithm 21 corresponding to each application to be executed in the virtual machine/container on the basis of the data, a procedure for acquiring the resource information from the resource database and selecting the server 31 corresponding to the optimization purpose of the optimization algorithm 21 from server information related to the server 31 described in the resource information on the basis of the predetermined server priority, and a procedure for executing the optimization algorithm 21 to the server 31 selected on the basis of the predetermined server priority and executing the optimal arrangement estimation of the virtual machine/container.

Thus, the program acquires the resource information from the resource database and can select the server 31 corresponding to the optimization purpose of the optimization algorithm 21 from the server information related to the server 31 described in the resource information on the basis of the predetermined server priority. Then, the program can execute the optimization algorithm 21 to the server 31 selected based on the predetermined server priority, and execute the optimal arrangement estimation of the virtual machine/container.

Therefore, the program can reduce the power consumption as a whole data center while satisfying the individual performance requirements of the application.

(8) A virtual machine/container control system 100 is characterized in that the virtual machine/container control system includes the controller 10 that controls resources of virtual machines/containers which are either or both of the virtual machines and the containers constituted by the server 31 connected to the network, and the compute group 30 having a plurality of servers 31 for realizing a plurality of types of virtual machines/containers as computes and, the controller 10 includes the monitor function unit 1 that collects data indicating the state of the compute group 30, the storage 4 that stores the resource information indicating the resources of the plurality of types of virtual machines/containers in the resource database, a scheduler 2 that acquires data collected by the monitor function unit 1 and selects the optimization algorithm 21 corresponding to each application to be executed in the virtual machines/containers on the basis of the data, and the resource management unit 3 that acquires the resource information from the resource database and selects the server 31 corresponding to the optimization purpose of the optimization algorithm 21 from server information related to the server 31 described in the resource information on the basis of the predetermined server priority, and the scheduler 2 executes the optimization algorithm 21 to the server 31 selected by the resource management unit 3 on the basis of the predetermined server priority, and executes the optimal arrangement estimation of the virtual machine/container.

Thus, the virtual machine/container control system 100, in the resource management unit 3, acquires the resource information from the resource database, and can select the server 31 corresponding to the optimization purpose of the optimization algorithm 21 from server information related to the server 31 described in the resource information on the basis of the predetermined server priority. Then, the virtual machine/container control system 100 executes, in the scheduler 2, the optimization algorithm 21 to the server 31 selected by the resource management unit 3 on the basis of the predetermined server priority, and can execute the optimal arrangement estimation of the virtual machine/container.

Thus, the virtual machine/container control system 100 can reduce the power consumption as a whole data center while satisfying the individual performance requirements of the application.

Note that the present invention is not limited to the embodiment described above, and various modifications can be made by a person of ordinary skill in the art within the technical idea of the present invention.

### REFERENCE SIGNS LIST

1 Monitor function unit
2 Scheduler
3 Resource management unit
4 Storage
10 Controller (resource allocation update device)
21 Optimization algorithm
30 Compute group
31 Server
100 Virtual machine/container control system

1. A resource allocation update device comprising:
a monitor function unit, including one or more processors, configured to collect data indicating a state of a compute group having a plurality of servers for realizing a plurality of types of virtual machines/containers as computes;
a storage unit configured to store resource information indicating resources of the plurality of types of virtual machines/containers in a resource database;
a scheduler, including one or more processors, configured to acquire the data collected by the monitor function unit and select an optimization algorithm corresponding to each application to be executed in a virtual machine/container of the plurality of types of virtual machines/containers based on the acquired data; and
a resource management unit, including one or more processors, configured to acquire the resource information from the resource database and select a server corresponding to an optimization purpose of the optimization algorithm from server information related to the server described in the resource information based on a predetermined server priority,
wherein the scheduler is configured to execute the optimization algorithm for the server selected by the resource management unit based on the predetermined server priority and executes an optimal arrangement estimation of the virtual machine/container.

2. The resource allocation update device according to claim 1, wherein the resource management unit is configured to select a server to be an arrangement destination candidate corresponding to the optimization purpose of the optimization algorithm from a predetermined power mode according to the predetermined server priority.

3. The resource allocation update device according to claim 2, wherein in response to selecting a server from the predetermined power mode, the resource management unit is configured to select the server in which a power supply is ON preferentially over the server in which the power supply is OFF, and does not select a server in which the power supply is ON and in which performance is prioritized as the server to be the arrangement destination candidate in the predetermined power mode in which power consumption is prioritized.

4. The resource allocation update device according to claim 3, wherein the resource management unit is configured to turn off the power supply to a server not used as a resource among the servers indicated by the resource information.

5. The resource allocation update device according to claim 1,
wherein the optimization purpose includes at least one purpose of performance and power consumption, and
the resource management unit is configured to: select a server that changes a clock frequency of the virtual machine/container in accordance with a load of the application when the optimization purpose prioritizes the power consumption, and select a server that releases a constraint to change a clock frequency of the virtual machine/container in accordance with a load of the application when the optimization purpose prioritizes the performance.

6. A resource allocation update method comprising:
collecting, by a resource allocation update device, data indicating a state of a compute group having a plurality of servers for realizing a plurality of types of virtual machines/containers as computes;
storing resource information indicating resources of the plurality of types of virtual machines/containers in a resource database;
acquiring the collected data and selecting an optimization algorithm corresponding to each application to be executed in a virtual machine/container of the plurality of types of virtual machines/containers based on the acquired data;
acquiring the resource information from the resource database and selecting a server corresponding to an optimization purpose of the optimization algorithm from server information related to the server described in the resource information based on a predetermined server priority; and
executing the optimization algorithm on the server selected based on the predetermined server priority and executing an optimal arrangement estimation of the virtual machine/container.

7. (canceled)

8. A virtual machine/container control system comprising:
a resource allocation update device, including one or more processors, configured to control resources of virtual machines/containers which are one or both of a virtual machine and a container constituted by servers connected to a network; and
a compute group having a plurality of servers for realizing a plurality of types of virtual machines/containers as computes, wherein
the resource allocation update device comprises:
a monitor function unit, including one or more processors, configured to collect data indicating a state of the compute group;
a storage unit configured to store resource information indicating resources of the plurality of types of virtual machines/containers in a resource database;
a scheduler, including one or more processors, configured to acquire the data collected by the monitor function unit and select an optimization algorithm corresponding to each application to be executed in a virtual machine/container of the plurality of types of virtual machines/containers based on the data; and
a resource management unit, including one or more processors, configured to acquire the resource information from the resource database and select a server corresponding to an optimization purpose of the optimization algorithm from server information related to the server described in the resource information based on a predetermined server priority, and
the scheduler is configured to execute the optimization algorithm for the server selected by the resource management unit based on the predetermined server priority, and executes an optimal arrangement estimation of the virtual machine/container.
